(19) United States
(12) Patent Application Publication
(10) Pub. No.: US 2007/0091080 A1
(43) Pub. Date: Apr. 26, 2007

(54) Non-volatile display for an electronic device having a reset circuit

(76) Inventors: Martin Ek, Dalby (SE); Stefan Sorensson, Sodra Sandby (SE)

Correspondence Address: MYERS BIGEL SIBLEY & SAJOVEC, P.A., P.O. BOX 37428, RALEIGH, NC, 27627, US

(21) Appl. No.: 11/254,395

(22) Filed: Oct. 20, 2005

(51) Int. Cl. G09G 5/00

(52) U.S. Cl. 345/204

(57) ABSTRACT

A display unit for a portable electronic device includes a display panel having a plurality of display elements and configured to display information after a power supply signal to the display panel is interrupted, and a display driver circuit configured to control the presentation of information by the display panel. The display driver circuit is further configured to control a state of at least some of the display elements in response to a reset signal. The display unit further includes a reset circuit coupled to the display driver circuit and configured to generate a reset signal in response to an interruption of the power supply signal. The reset circuit includes an energy storage element configured to supply energy to the display unit while the display elements are reset.

### FIELD OF THE INVENTION

The present invention relates to displays for portable electronic devices and in particular to a non-volatile display unit for a portable electronic device.

### BACKGROUND

In a portable electronic device such as a mobile phone, one or more displays are typically provided for presentation of information to a user. The use of displays in portable electronic devices may be limited by problems associated with high power consumption by the displays. Several solutions to the problem of power consumption by displays have been proposed, and some of them have been implemented in large scale.

Typically, a display for an electronic device consumes power when it is active, i.e. when it displays information to a user. Because of that, when power is restricted in some way, for instance because of limited battery power in a mobile phone, it may be impractical and/or inefficient to keep the display active (i.e. to keep power supplied to the display) at all times when the phone is on. A display that loses information when power to the display is interrupted may be referred to as a “volatile” display. A volatile display may in some cases present a problem, for instance because relevant information may not be presented instantly, because the display may first have to be activated.

In order to address this problem, a display may be provided that does not require power to be able to present information. Such a display may be referred to as a “non-volatile” display. Typically, this may be provided by means of a bistable display including display elements (pixels) having at least two stable states, such as white and black, that will be maintained even if power to the display is switched off or otherwise interrupted. Normally, such a display is referred to as a “bistable display”.

A bistable display may not lose information even when power to the display is switched off or otherwise interrupted, but may continue to display the same image as shown before power was interrupted. However, a bistable display requires power to be able to shift the state of the display elements (e.g. from black to white or vice versa). Typically, a bistable display has relatively low power consumption, since power is only required during short periods of time to shift the state of the display elements, but may not be required to maintain each pixel a particular state. Because of their low power consumption, such bistabile displays may find application in particular as sub-displays in portable electronic devices, as well as in other applications where low power consumption is a concern.

Nevertheless, conventional bistable displays may suffer from a number of drawbacks. A particular problem is that when power to a conventional bistable display is interrupted, the display may continue to show the last image that was on the screen when power was interrupted. In the case of such a bistable display used in a mobile phone, the display may not always present relevant information to the user.

An example could be the indication of battery status of the phone. Because a conventional bistable display continues to display the last image, irrespective of whether power is supplied or not, a user may be presented with incorrect information by the display. For example, a display may continue to display a battery status indicator that indicates some remaining battery life even when the battery is low. A user may therefore believe that the battery power is sufficient to make a call, even if the battery power is so low that power was cut off. This might provide the user with incorrect information, such that he/she may try to place a call, even if it is not possible, because of the old information shown. This may cause problems, or may at least be irritating to a user.

### SUMMARY

A display unit for a portable electronic device according to some embodiments of the invention includes a display panel including a plurality of display elements and configured to display information after a power supply signal to the display panel is interrupted, and a display driver circuit configured to control the presentation of information by the display panel. The display driver circuit includes a first terminal configured to receive a reset signal indicative of an interruption of the power supply signal and a second terminal configured to receive the power supply signal, and is further configured to control a state of at least a portion of the plurality of display elements of the display panel in response to the reset signal. The display unit further includes a reset circuit coupled to the display driver circuit and configured to generate a reset signal in response to an interruption of the power supply signal, the reset circuit including an energy storage element configured to supply energy to the display unit while the at least a portion of the plurality of display elements are reset. The energy storage element may include a capacitor.

The display driver circuit may be configured to set all of the plurality of display elements of the display panel to a stable state in response to the reset signal. The stable state may be one of a black state or a white state.

The display driver circuit may be configured to cause the at least a portion of the display elements of the display panel to display an image in response to the reset signal.

The display panel may include a bistable display panel, and the plurality of display elements of the display panel may be independently switchable between two stable states.

The display driver circuit may include a third terminal configured to receive a supplemental power supply, and the reset circuit may further include an energy storage element connected to the third terminal.

The reset circuit may further include a regulator element configured to provide a stable voltage to the display unit while the display driver circuit controls the state of the at least a portion of the plurality of display elements of the display panel in response to the reset signal. The reset signal may include a falling flank of the power supply signal.

A display unit according to some embodiments of the invention may further include a reset module configured to generate a reset signal in response to a signal including a falling flank of the power supply signal and/or an indication that a pulse train has ceased. The pulse train may be generated by a pulse train generation circuit coupled to the reset module. The pulse train generation circuit may include a CPU coupled to the reset module.

A rectifying element may be provided between the energy storage device and a power supply to obstruct energy stored in the energy storage device from being lost. The rectifying element may include a diode.

### BRIEF DESCRIPTION OF THE DRAWINGS

The accompanying drawings, which are included to provide a further understanding of the invention and are incorporated in and constitute a part of this application, illustrate certain embodiment(s) of the invention. In the drawings:

FIG. 1 is a schematic block diagram of a display for a portable electronic device according to some embodiments of the present invention; and

FIG. 2 is a schematic block diagram of a display for a portable electronic device according to further embodiments of the present invention.

### DETAILED DESCRIPTION OF EMBODIMENTS OF THE INVENTION

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

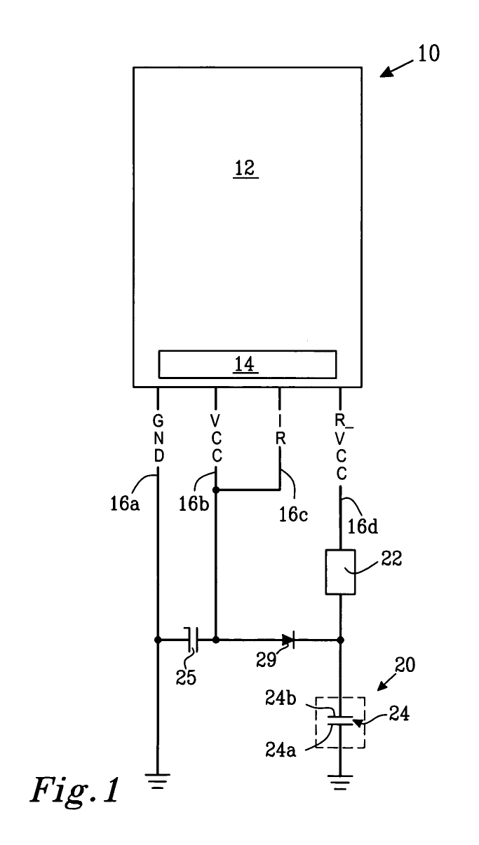

FIG. 1 is a schematic block diagram illustrating a display unit 10 for a portable electronic device according to some embodiments of the present invention. The display unit 10 includes a bistable display panel 12, a display driver 14 including an interface 16 having a first terminal 16a electrically connected to ground (GND), a second terminal 16b electrically connected to a primary power source 25 which generates a primary voltage signal (VCC), a third terminal 16c configured to receive a signal (IR) for resetting at least a portion of the display elements of the display unit 10, and a fourth terminal 16d configured to receive a supplemental power signal (R_VCC) for the display unit 10. The bistable display panel 12 includes a plurality of display elements (e.g. pixels) arranged in a two-dimensional array. The terminals 16a -d are each provided for receiving input from a reset circuit 20 connected thereto and providing a reset operation in case of the primary power supply is interrupted.

The display driver 14 is configured to set at least some of the plurality of pixels of the display panel 12 to a predetermined image, for example according to a register setting of the display driver 14, in response to a reset signal IR received at the third terminal 16c. The reset signal IR may include, for example, a falling flank of a power supply signal VCC supplied at the second terminal 16b by the primary voltage supply 25. For example, the display driver 14 may be configured to cause a portion of the plurality of pixels to display a blank image (e.g. all white or all black) in response to a reset signal received at the third terminal 16c. In some embodiments, the display driver 14 may cause all of the pixels of the display panel 12 to display a blank image in response to a reset signal IR received at the third terminal 16c. Alternatively or additionally, the display driver 14 may be configured to cause the display panel 12, or a portion thereof, to display a predetermined image or message in response to a reset signal received at the third terminal 16c. For example, if at the time the primary power supply signal VCC is interrupted, the display panel 12 is displaying a battery level indicator in a portion of the display, the display driver 14 may be configured to cause the display panel 12 to display a “no power” indication and/or icon instead of the battery level indicator at the portion of the display where the battery level indicator was displayed.

The display panel 12 may include a bistable display panel, such as, but not limited to, a liquid crystal display including liquid crystals providing an array of pixels for displaying information. A pixel of a bistable liquid crystal display may have two different stable states, e.g. black or white, that can be switched by a voltage signal applied to the pixel, such that a two-dimensional matrix of pixels can be controllably set reset to present display data. As a default setting, a bistable display panel, such as the display panel 12, may periodically renew the display data, and may latch the latest data when power is turned off. Therefore, a bistable display panel 12 can show the latest data under on-line, off-line or power-off conditions as a default. Thus, a bistable liquid crystal display may provide low power consumption as compared to conventional displays requiring power to be able to present information. Bistable displays may be implemented using technology, such as MEMS technology, other than liquid crystal display technology. Thus, the display panel 12 may, but need not, include a liquid crystal display.

The reset circuit 20 includes a regulator 22 connected to the fourth terminal 16d and to a capacitor 24. The capacitor 24 has a first terminal 24a coupled to ground and a second terminal 24b coupled to the regulator 22. The regulator 22 and the capacitor 24 may provide a stable voltage supply to the display unit 10 via the fourth terminal 16d (i.e. through R_VCC) until the reset operation triggered by the reset signal IR applied at the third terminal 16c has finished. In some embodiments, the regulator 22 and the capacitor may supply the stable voltage supply through the second terminal 16b (i.e. through VCC) until the reset operation has finished. The second terminal 24b of the capacitor 24 is also connected through a rectifying element 26, such as a diode, to the voltage supply VCC (and IR). The rectifying element 26 may permit energy to be stored in the capacitor 24 by the primary power supply signal VCC, but to inhibit energy stored in the capacitor 24 from being lost to the VCC line and/or to other devices connected thereto.

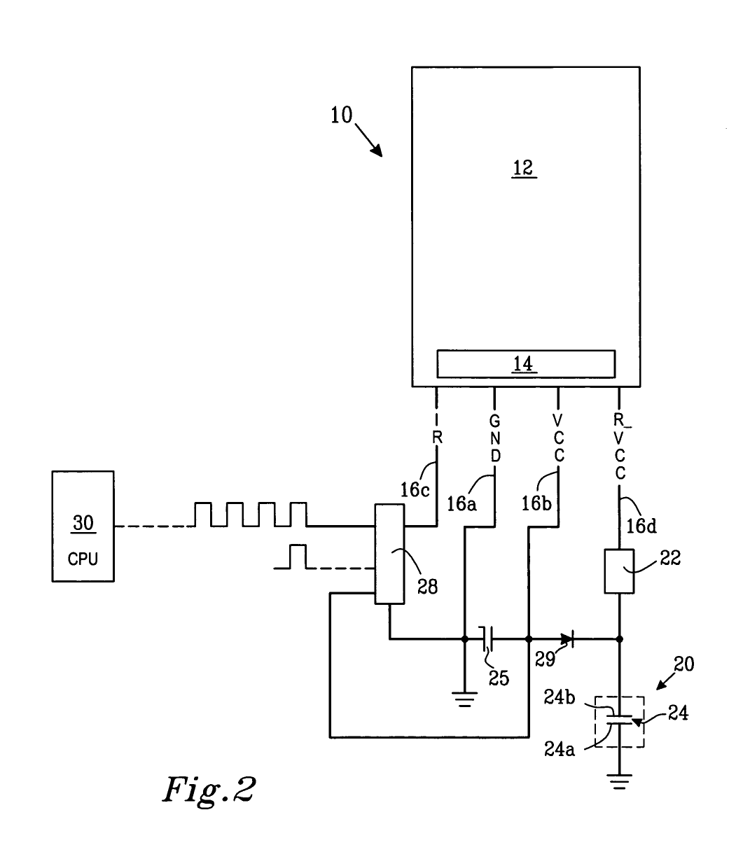

FIG. 2 is a schematic block diagram showing further embodiments of the present invention. In the embodiments illustrated in FIG. 2, a reset module 28 is coupled to the third terminal 16c and is configured to generate a reset signal IR in response to an interruption of the primary power supply signal VCC to the display panel 12. The reset module 28 may be configured to receive a pulse train of “watchdog pulses” that may be generated by a pulse generating circuit 30 whenever the primary voltage supply 25 is active. For example, the watchdog pulses may be generated by a controlling CPU in the device. The reset module 28 may be configured to generate a reset signal IR if the watchdog pulses cease to be received by the reset module 28. That is, since the watchdog pulses may be generated whenever the primary power supply 25 is active, when the watchdog pulses cease, the reset module 28 may generate a reset signal IR indicative of an interruption of the primary power supply 25.

The reset module 28 is also connected to the third terminal 16c for supplying the reset signal IR to the driver circuit 14. The reset module 28 may also be connected to ground and to the first terminal 16a. Accordingly, the reset signal IR may be triggered by the reset module 28 if either the primary power supply signal VCC is interrupted (i.e. in response to the detection by the reset module 28 of a falling edge of the power supply signal VCC at the first terminal 16a ), or if the watchdog pulses cease to be received. The reset signal IR may also be triggered by the receipt of a pulse via a system reset input 29 of the reset module 28.

Although embodiments of the present invention have been described with reference to exemplary circuits/display panels illustrated in FIGS. 1 and 2, it will be understood that the invention is not limited to the details of the described embodiments. For instance, embodiments of the invention may be advantageously employed in connection with any display suffering from similar problems, i.e. one that may display incorrect or out of date information if power thereto is interrupted.

Moreover, while embodiments of the invention have been described in relation to a mobile phone, embodiments of the invention may be utilized in any kind of electronic device having a restricted energy source, for instance having batteries with limited capacity. Thus, the present invention is by no means to be limited to application in a mobile phone only.

In the drawings and specification, there have been disclosed typical embodiments of the invention and, although specific terms are employed, they are used in a generic and descriptive sense only and not for purposes of limitation, the scope of the invention being set forth in the following claims.

What is claimed is:

1. A display unit for a portable electronic device, comprising:
a display panel including a plurality of display elements and configured to display information after a power supply signal to the display panel is interrupted,
a display driver circuit configured to control the presentation of information by the display panel, the display driver circuit comprising a first terminal configured to receive a reset signal indicative of an interruption of the power supply signal and a second terminal configured to receive the power supply signal, and being further configured to control a state of at least a portion of the plurality of display elements of the display panel in response to the reset signal; and
a reset circuit coupled to the display driver circuit and configured to generate a reset signal in response to an interruption of the power supply signal, the reset circuit comprising an energy storage element configured to supply energy to the display unit while the at least a portion of the plurality of display elements is reset.

2. A display unit according to claim 1, wherein the display driver circuit is configured to set all of the plurality of display elements of the display panel to a stable state in response to the reset signal.

3. A display unit according to claim 2, wherein the stable state is one of a black state or a white state.

4. A display unit according to claim 1, wherein the display driver circuit is configured to cause the at least a portion of the display elements of the display panel to display an image in response to the reset signal.

5. A display unit according to claim 1, wherein the display panel comprises a bistable display panel, and wherein the plurality of display elements of the display panel are independently switchable between two stable states.

6. A display unit according to claim 1 wherein the energy storage element comprises a capacitor.

7. A display unit according to claim 1, wherein the display driver circuit comprises a third terminal configured to receive a supplemental power supply, and wherein the reset circuit further comprises an energy storage element connected to the third terminal.

8. A display unit according to claim 1, wherein the reset circuit further comprises a regulator element configured to provide a stable voltage to the display unit while the display driver circuit controls the state of the at least a portion of the plurality of display elements of the display panel in response to the reset signal.

9. A display unit according to claim 1, wherein the reset signal comprises a falling flank of the power supply signal.

10. A display unit according,to claim 1, further comprising a reset module configured to generate a reset signal in response to a signal comprising a falling flank of the power supply signal and/or an indication that a pulse train has ceased.

11. A display unit according to claim 10, wherein the pulse train is generated by a pulse train generation circuit coupled to the reset module.

12. A display unit according to claim 11, wherein the pulse train generation circuit comprises a CPU coupled to the reset module.

13. A display unit according to claim 1, wherein a rectifying element is provided between the energy storage device and a power supply to obstruct energy stored in the energy storage device from being lost.

14. A display unit according to claim 13, wherein the rectifying element comprises a diode.
